(19) United States
(12) Patent Application Publication
(10) Pub. No.: US 2004/0200207 A1
(43) Pub. Date: Oct. 14, 2004

(54) Gas turbine apparatus

(76) Inventors: Terence McKelvey, Chiba (JP); Eishi Marui, Kanagawa (JP); Masahiro Miyamoto, Kanagawa (JP); Tadashi Kataoka, Chiba (JP); Tai Furuya, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/483,092

(22) PCT Filed: Jan. 21, 2003
(86) PCT No.: PCT/JP03/00478

(30) Foreign Application Priority Data
Jan. 21, 2002 (JP) 2002/12123
Feb. 20, 2002 (JP) 2002/43473

(51) Int. Cl. F02C 9/28

(52) U.S. Cl. 60/39.281

(57) ABSTRACT

A gas turbine apparatus is provided which prevents a sudden rise in temperature in the event of changing a speed such as upon start-up, thereby obviating a reduction in lifetime. The apparatus comprises a rotational speed control unit, acceleration control unit, low signal selector, and an opening operating unit. The rotational speed control unit receives a current rotational speed and a predetermined target rotational speed of a turbine, and processes them to output a control signal indicative of an opening degree of a fuel control valve to make the turbine rotate at the target rotational speed. The target rotational speed is set as a predetermined downwardly convex monotone increasing function having an elapsed time as a variable during a start-up period to rated condition. The acceleration control means receives a current process acceleration value and a predetermined target acceleration value, and processes them to output a control signal indicative of an opening of the fuel control valve to bring the acceleration of the turbine to the target acceleration. The low signal selector receives the control signals from the rotational speed and acceleration control means, and selects the control signal indicative of the smaller opening degree. The opening operating unit automatically operates the fuel control valve in response to the selected control signal.

### TECHNICAL FIELD

The present invention relates to a gas turbine apparatus, and more particularly, to a turbine control technique in the gas turbine apparatus.

### BACKGROUND ART

A typical gas turbine apparatus is comprised of the following basic components: a turbine rotatably mounted on a rotation shaft; a combustor for burning a mixture of a fuel and air to generate a combustion gas; a fuel control valve, an opening of which is variable to adjust an amount of fuel supplied to the combustor; and an air compressor driven by the turbine for feeding compressed air to the combustor.

In a gas turbine apparatus as above, the combustor is supplied with the fuel, an amount of which is adjusted by the fuel control valve, and with the air compressed by the air compressor (compressed air), respectively. Then, a resulting air/fuel mixture is formed within the combustor and burnt to generate a high-temperature and high-pressure combustion gas. This gas is supplied to the turbine, to rotate it at a high speed. Such a gas turbine apparatus also conducts feedback control for control of the turbine such that a rotational speed and rotational acceleration of the turbine approach predetermined target values, respectively. Such feedback control involves detecting a current rotational speed and acceleration of the turbine, calculating deviations of these detected values from respective target values, and adjusting an opening degree of the fuel control valve to supply fuel such that any deviation is minimized. In other words, the fuel control valve opening is adjusted to increase or decrease an amount of fuel supplied to the combustor, to thereby control a temperature of the combustion gas supplied to the turbine and hence control a rotational speed and acceleration of the turbine.

FIG. 1 is a graph explaining how a variety of values fluctuate during a start-up mode of a gas turbine apparatus in a prior art. In FIG. 1, NR shows a graph indicating the rotational speed of a turbine; FCV, the opening of a fuel control valve; and EGT, an exhaust gas temperature, respectively. The exhaust gas temperature refers to the temperature at the outlet of the turbine. The start-up mode is initiated at time to by driving the turbine under a start-up motor to rotate. Then, as the driven turbine reaches a rotational speed NR1 at which ignition of the air/fuel mixture can be made, the rotational speed of the start-up motor is controlled to maintain the rotational speed of the turbine at NR1, and the air/fuel mixture is ignited. Later, as the air/fuel mixture is ignited to generate a combustion gas at time t1, the combustion gas is supplied to the turbine, so that the rotational speed of the turbine increases to a rated rotational speed NR2 with the aid of a driving force generated by the combustion gas. From time t1 at which the air/fuel mixture is ignited to time t2 at which the rotational speed of the turbine reaches the rated rotational speed NR2, acceleration of the turbine is controlled by the foregoing feedback control such that the rotational speed increases toward the previously-set target value (or rated rotational speed) NR2.

However, the conventional start-up control for a gas turbine apparatus switches to feedback control from time t1 after a rotational speed of the turbine is maintained constant, which results in a problem that working life of the gas turbine apparatus, particularly the combustor, is reduced, as is described in detail below.

A first factor in reducing the working life is a sudden rise in the exhaust gas temperature (EGT) from the turbine. Specifically, since the turbine is subject to a moment of inertia under its own mass, a large driving force is required to instantaneously change the rotational speed of the turbine. For this reason, a feedback control instruction is issued to substantially instantaneously change the rotational speed of the turbine at time t1, at which the control is changed from the motor-based low speed rotation control to a feedback control.

In this event, a large amount of fuel is required to effect a rapid change in the rotational speed of the turbine, so that the feedback control instruction suddenly increases the opening of the fuel control valve by a significant large degree, as indicated by the graph FCV in FIG. 1. As a result, as indicated in the graph EGT in FIG. 1, the amount of fuel is suddenly increased, thereby resulting in a sudden rise in the exhaust gas temperature, which has a negative impact on the gas turbine apparatus, particularly the combustor, and reduces the working life of the apparatus. It is to be noted here that such a problem is not limited to start-up of a gas turbine apparatus, and may also arise when an instruction is issued to suddenly change a rotational speed of the turbine in a feedback control operation.

A second factor causing a reduction in the lifetime of the apparatus resides in the intensity of the combustion of the air/fuel mixture to increase the rotational speed of the gas turbine apparatus when the gas turbine apparatus is at a low temperature. In other words, conventional feedback control increases a rotational speed of the turbine by controlling a process acceleration to be kept at a predetermined target acceleration value, irrespective of an initial temperature of the gas turbine apparatus, particularly, a temperature of air supplied to the combustor. This will be described below with reference to FIG. 2.

FIG. 2 is a diagram showing how a variety of values fluctuate when a cold gas turbine apparatus is started up in accordance with a conventional method. Similar to FIG. 1, NR is a graph indicating the rotational speed of the turbine, and EGT is a graph indicating the exhaust gas temperature at the outlet of the turbine in FIG. 2. When the turbine apparatus, particularly, air supplied to the combustor is hot, a significant amount of fuel is not required for speeding up the turbine with a relatively high target acceleration ACCELL. On the other hand, when the air supplied to the combustor is cold, a larger amount of fuel is required for speeding up the turbine with the same target acceleration ACCELL. For this reason, upon cold starting-up, a larger amount of supplied fuel causes the air/fuel mixture to intensively burn, resulting in a sudden rise in the exhaust gas temperature, as indicated by the graph EGT in FIG. 2.

Such intensive burning of the air/fuel mixture results in thermal stress in each component member of the gas turbine apparatus, reducing the lifetime of the gas turbine apparatus. Particularly, in the combustor in which the air/fuel mixture is burnt, a combustion chamber (liner) is locally heated to a high temperature, leading to the generation of thermal stress arising from a difference in temperature among different locations of the combustion chamber. Consequently, the combustor tends to have an extremely limited working life.

An intensity of combustion of the air/fuel mixture could be lessened by setting a target acceleration value of the turbine to a relatively small value, so as to reduce a driving force required to accelerate the turbine. However, as indicated by a dotted line graph NR′ in FIG. 2, when the target acceleration is set at ACCEL2 lower than ACCEL1, the rotational speed NR of the turbine slowly increases, so that a longer time is taken to reach the rated rotational speed NR2. Actually, the temperature is not always the same when the gas turbine apparatus is in a start-up mode. Therefore, when the gas turbine apparatus is started up at a high temperature (at which the turbine can be rapidly accelerated by setting a relatively large target acceleration without intense combustion of the air/fuel mixture), an unnecessarily long time will be taken until the turbine reaches the rated rotational speed NR2 if the target acceleration is set at a small value.

### DISCLOSURE OF THE INVENTION

The present invention has been made in view of the problems of the prior art example described above, and it is an object of the invention to prevent a reduction in the working life of a gas turbine apparatus associated with a change in speed of a turbine upon start-up and the like.

To achieve the stated object, a gas turbine apparatus according to a first aspect of the present invention, in which a mixture of air and fuel is burnt, and a turbine is supplied with a combustion gas generated by the combustion to drive said turbine to rotate, said gas turbine apparatus, comprises:

a turbine control unit for controlling an opening degree of a fuel control valve to control a rotational speed of said turbine, said turbine control unit controlling said opening degree, when changing the rotational speed of said turbine, to monotonically increase the acceleration of the rotational speed of said turbine in a period from a first time at which said change in speed is started to a second time at which said turbine reaches a predetermined fixed target rotational speed.

In a preferred embodiment of the gas turbine apparatus, the change in speed is an increase in speed in a start-up mode of the gas turbine apparatus, the first time is a time at which an air/fuel mixture is ignited, and the second time is a time at which the turbine reaches a rated rotational speed as the fixed target rotational speed, and the turbine control unit comprises rotational speed control means to which a process value of a current rotational speed of the turbine and a predetermined variable target rotational speed are provided, for processing them to output a first control signal indicative of an opening degree of said fuel control valve to bring the rotational speed of the turbine to the variable target rotational speed, the variable target rotational speed being set as a predetermined downwardly convex monotone increasing function having a variable factor of an elapsed time over a period from the first time to the second time.

In the preferred gas turbine apparatus, the turbine control unit further comprises: acceleration control means to which a process value of a current acceleration of the rotational speed of the turbine and a predetermined constant target acceleration are provided, for processing them to output a second control signal indicative of an opening degree of the fuel control valve to bring the acceleration of the rotational speed of the turbine to the constant target acceleration; selecting means connected to receive the first and second control signals from the rotational speed control means and the acceleration control means, for selecting one of the control signals which is indicative of a smaller opening degree; and means for automatically operating the fuel control valve in response to the control signal selected by said selecting means, whereby the turbine control unit controls the opening degree of the fuel control valve initially based on the first control signal and subsequently based on the second control signal in the start-up mode.

A gas turbine apparatus according to a second aspect of the present invention in which a mixture of air and fuel is burnt, and a turbine is supplied with a combustion gas generated by the combustion to drive said turbine to rotate, said gas turbine apparatus comprising:

a turbine control unit for controlling an opening degree of a fuel control valve to control a rotational speed of said turbine, said turbine control unit controlling the opening degree, when said gas turbine apparatus is in a start-up mode, such that an acceleration of the rotational speed of said turbine becomes lower as said apparatus is colder.

In the gas turbine apparatus according to the second aspect of the invention, it is preferable to further comprises: a heat exchanger for heating air supplied to a combustor making use of heat of a combustion gas from the turbine; and an air temperature sensor for detecting the temperature of the air supplied to the combustor, wherein the turbine control unit employs the air temperature from the air temperature sensor as the temperature of the gas turbine apparatus for controlling the acceleration of the turbine.

Furthermore, in the gas turbine apparatus according to the second aspect of the invention, it is preferable that the turbine control unit comprises: target acceleration changing means for modifying a predetermined reference target acceleration value of the rotational speed of the turbine, the target acceleration changing means multiplying an absolute value of a deviation of the air temperature from the air temperature sensor from a predetermined maximum or minimum air temperature by a predetermined coefficient, and subtracting a resulting product from the reference target acceleration to output a modified target acceleration; and acceleration control means to which a process value of a current acceleration of the rotational speed of the turbine and the modified target acceleration value is provided, for processing them to output a control signal indicative of an opening degree of the fuel control valve to bring the acceleration of the rotational speed of the turbine to the modified target acceleration.

In addition, it is preferable that the turbine control unit further comprises: rotational speed control means to which process value of a current rotational speed of the turbine and a predetermined constant target rotational speed value are provided, for processing them to output a control signal indicative of an opening degree of the fuel control valve to bring the rotational speed of said turbine to the predetermined target rotational speed; selecting means connected to receive the control signals respectively from the rotational speed control means and the acceleration control means, for selecting one of the control signals which is indicative of a smaller opening degree; and means for automatically operating the fuel control valve based on the control signal selected by the selecting means. It is possible to modify the target rotational speed being set as a downwardly convex monotone increasing function having a variable of an elapsed time.

### BRIEF DESCRIPTION OF THE DRAWINGS

FIG. 1 shows schematic graphs of a rotational speed NR of a turbine, an exhaust gas temperature EGT, and an opening degree FCV of a fuel control valve in a start-up mode of a gas turbine apparatus according to a prior art;

FIG. 2 illustrates graphs explaining the influence exerted by a target acceleration for the rotational speed of the turbine in a start-up mode of a gas turbine apparatus according to a prior art;

FIG. 3A is a general block diagram illustrating a gas turbine apparatus according to a first embodiment of the present invention, and FIG. 3B is a block diagram illustrating a configuration of a turbine control unit included in the gas turbine apparatus of FIG. 3A;

FIGS. 4A, 4B and 4C show graphs explaining the principle of the first embodiment of the present invention, in which FIG. 4A is a graph schematically showing a target rotational speed which is set in the turbine control unit of FIG. 3B; FIG. 4B is a graph schematically showing a rotational speed of the turbine which may vary depending on a target acceleration value set in the turbine control unit of FIG. 3B; and FIG. 4C is a graph schematically showing a rotational speed of the turbine finally controlled by the turbine control unit of FIG. 3B;

FIG. 5 illustrates explanatory graphs schematically showing a process rotational speed NR of the turbine, exhaust gas temperature EGT, and opening degree FCV of a fuel control valve in a start-up mode of the gas turbine apparatus according to the first embodiment of the present invention;

FIG. 6A is a general block diagram illustrating a gas turbine apparatus according to a second embodiment of the present invention, FIG. 6B is a block diagram illustrating a configuration of a turbine control unit included in the gas turbine apparatus, and FIG. 6C is a functional block diagram of a target acceleration changing unit in the turbine control unit; and

FIG. 7 shows explanatory graphs showing a process rotational speed NR of the turbine and exhaust gas temperature EGT, together with a process combustor inlet air temperature CIT, when the target acceleration is changed depending on the temperature in a start-up mode of the gas turbine apparatus according to the second embodiment of the present invention.

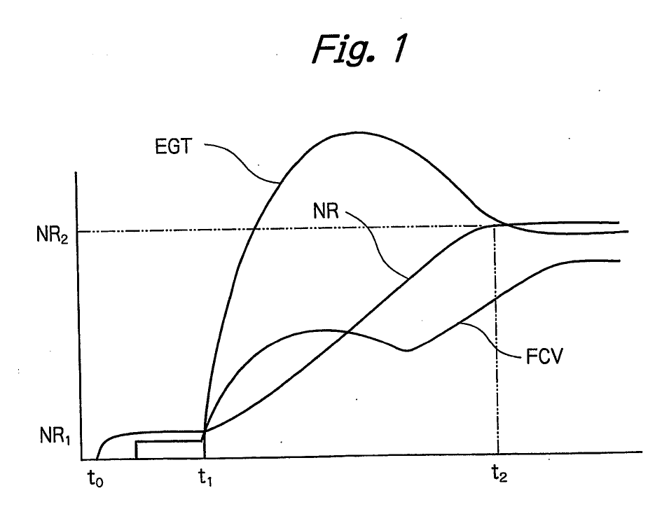

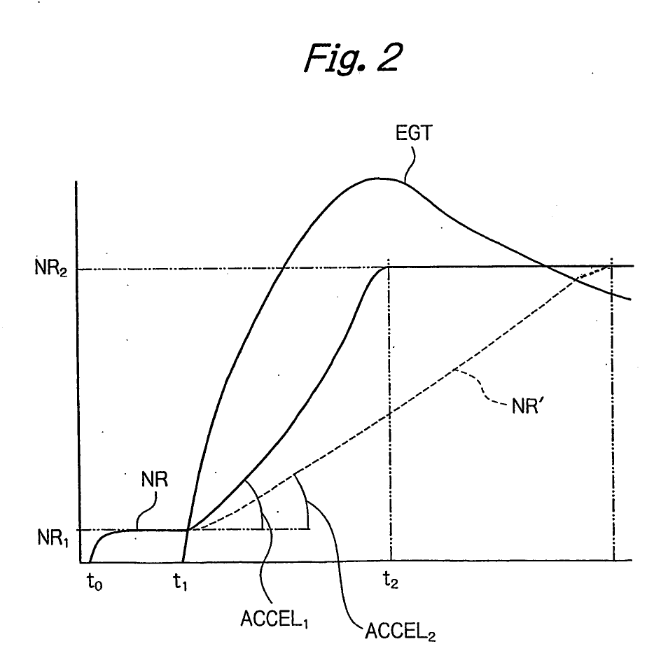

### BEST MODE FOR CARRYING OUT THE INVENTION

In the following, preferred embodiments of the present invention will be described in detail with reference to the drawings.

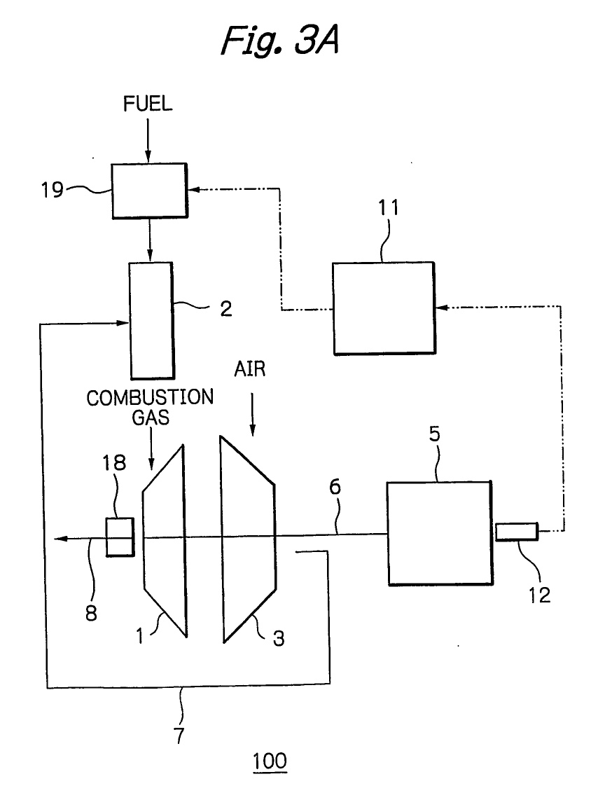

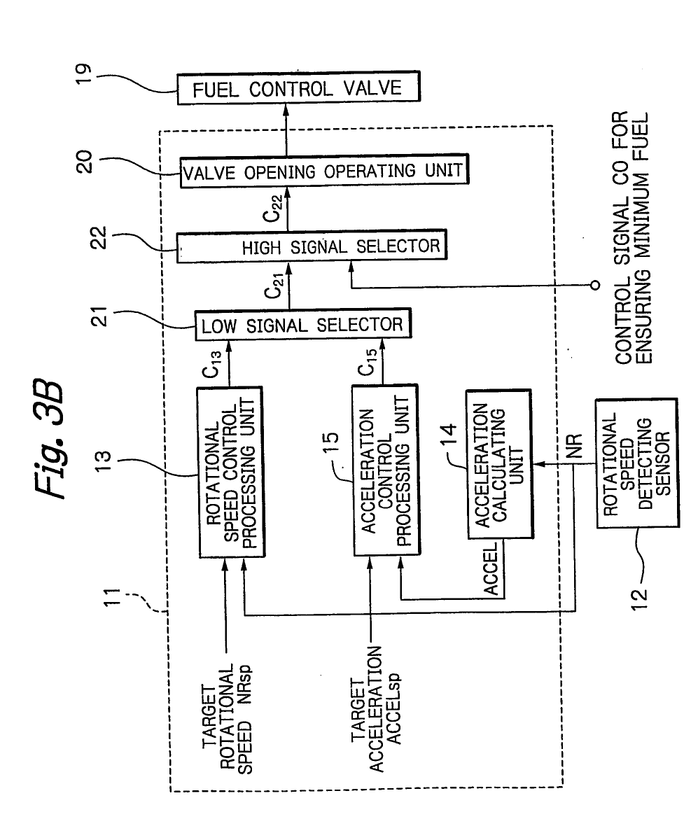

FIG. 3A is a general block diagram of a gas turbine apparatus 100 according to a first embodiment of the present invention, and FIG. 3B is a block diagram illustrating a general configuration of a turbine control unit 11 provided in the gas turbine apparatus 100.

As illustrated in FIG. 3A, the gas turbine apparatus 100 comprises a turbine 1; a combustor 2 for burning an air/fuel mixture composed of a fuel and air to generate a combustion gas; a fuel control valve 19 for adjusting the amount of fuel supplied to the combustor 2; and an air compressor 3 for supplying compressed air to the combustor 2. The gas turbine apparatus 100 also comprises a generator 5 and a rotational speed detecting sensor (NR sensor) 12 for detecting a rotational speed NR of the turbine 1, as well as the turbine control unit 11 having the configuration illustrated in FIG. 3B. The generator 5 is utilized as a start-up motor.

The turbine 1 has a plurality of rotor blades which receive a fluid for rotation, and is rotatably supported within a casing (not shown) through a rotation shaft 6. The air compressor 3 is configured to be driven by the turbine 1 through the rotation shaft 6 to compress air, and the compressed air is supplied to the combustor 2 through a pipe 7.

The fuel control valve 19 is disposed on the upstream side of the combustor 2. A fuel delivered from an appropriate fuel supply source (not shown) is supplied to the combustor 2 through the fuel control valve 19. The fuel control valve 19 effects variable valve opening degree under control of the turbine control unit 11, so that the amount of fuel supplied to the combustor 2 is adjusted by controlling the opening degree of the fuel control valve 19.

The air supplied from the air compressor 3 and the fuel supplied through the fuel control valve 19 form an air/fuel mixture in the combustor 2, and the air/fuel mixture is burnt to generate a high-temperature and high-pressure combustion gas. The generated combustion gas is supplied from the combustor 2 to the turbine 1, thereby causing the turbine 1 to rotate at high speed. A generator 5 is connected to one end of the rotation shaft 6, such that rotation of the turbine 1 is transmitted to the generator 5 through the rotation shaft 6 to generate electricity or electric power. A pipe 8 is connected on the downstream side of the turbine 1 for emitting exhaust gases, and an exhaust gas temperature measuring sensor (EGT sensor) 18 is disposed in the pipe 8 for measuring the temperature of exhaust gases (EGT).

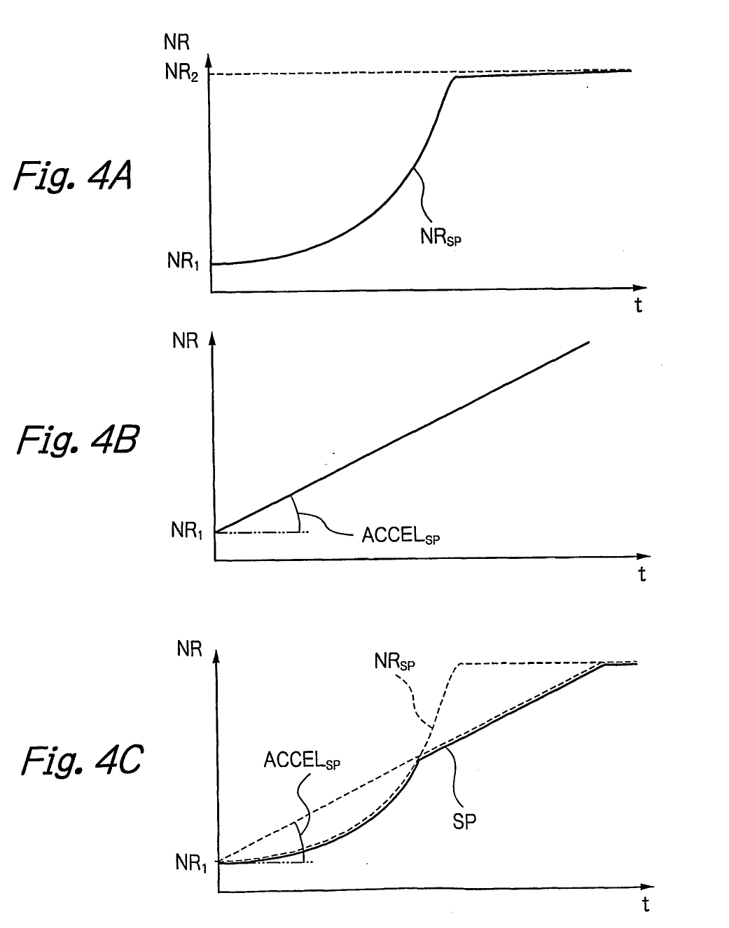

The turbine control unit 11 comprises a rotational speed control processing unit 13 for generating a control signal C13 to bring the rotational speed NR of the turbine 1 close to a predetermined target rotational speed NRsp (which varies as shown in FIG. 4A); an acceleration calculating unit 14 for calculating an acceleration (rotational acceleration) ACCEL of the turbine 1 based on the rotational speed NR from the rotational speed detecting sensor 12; and an acceleration control processing unit 15 for generating a control signal C15 to bring the acceleration ACCEL close to a predetermined target acceleration ACCELsp (which is substantially constant as shown in FIG. 4B). The turbine control unit 11 also comprises a valve opening operating unit 20 for operating opening of the fuel control valve 19; a low signal selector 21; and a high signal selector 22. The low signal selector 21 functions to pass only a signal indicating a lowest value of input signals, while the high signal selector 22 functions to pass only a signal indicating a highest value of input signals.

Description will now be made of the operation of the turbine control unit 11 having the above-described configuration. Upon receipt of a current rotational speed value (process value) NR of the turbine 1 from the rotational speed detecting sensor 12, the rotational speed control processing unit 13 calculates a deviation of the rotational speed value NR from a current target rotational speed value NRsp, generates the control signal C13 for minimizing deviation in rotational speed in accordance with a PID operation, and supplies the generated control signal C13 to the low signal selector 21. The acceleration control processing unit 15 receives the acceleration value ACCEL (calculated by the acceleration calculating unit 14 based on a signal indicative of the rotational speed NR from the rotational speed detecting sensor 12), calculates a deviation of the acceleration value ACCEL from the target acceleration value ACCELsp, generates the control signal C15 for minimizing deviation of acceleration in accordance with a PID operation, and supplies the generated control signal C15 to the low signal selector 21. The target rotational speed value NRsp and target acceleration value ACCELsp have been previously set in accordance with the present invention, and these settings will be described later with reference to FIG. 4. The term “control signal” used herein refers to a signal indicative of opening degree of the fuel control valve 19, and therefore means an “opening degree instruction signal”.

The low signal selector 21 compares the two control signals C13 and C15 applied thereto from the rotational speed control processing unit 13 and acceleration control processing unit 15, selects one of them which has a smaller value, and passes the selected control signal to the high signal selector 22 as a control signal C21. The high signal selector 22 compares a control signal C0 from a minimum fuel reserving unit (not shown) with the control signal C21 (C13 or C15) applied thereto from the low signal selector 21, selects the control signal having the larger value from these, and supplies the selected one to the valve opening operating unit 20 as a control signal C22. The minimum fuel reserving unit is utilized to supply a fuel (minimum fuel) required to maintain a combustion state of the air/fuel mixture. Accordingly, the control signal C0 indicates an opening degree for maintaining combustion even in the event of a sudden decrease in a load acting on the turbine 1. Therefore, normally the control signal C22 output from the high signal selector 22 consists of the control signal C21 (C13 or C15) from the low signal selector 21. When a sudden decrease in load need not be taken into account, the high signal selector 22 may be omitted.

The valve opening operating unit 20 determines a degree of change in opening of the fuel control-valve 19 from a current state, in response to the value of the control signal supplied from the high signal selector 22. Then, the opening of the fuel control valve 19 is adjusted by the determined amount, to thereby control an amount of fuel supplied to the turbine 1.

Now, description will be made of the settings of the target rotational speed NRsp and target acceleration ACCELsp respectively used in the rotational speed control processing unit 13 and acceleration control processing unit 15. FIG. 4A is a graph indicating a variety of the predetermined target rotational speed NRsp, and FIG. 4B is a graph schematically indicating a process rotational speed of the turbine when it is driven with the constant target acceleration ACCELsp. FIG. 4C shows a graph schematically illustrating a process rotational speed in accordance with the first embodiment of the invention, together with the graphs of FIGS. 4A and 4B which are superimposed one on the other. In all graphs, the horizontal axis represents an elapsed time t.

Conventionally, the target rotational speed is set at a constant value (the value of NR2 indicated by a dotted line in FIG. 4A) irrespective of the lapse of time. In this embodiment, on the contrary, the target rotational speed NRsp is set to change over time in a period in which the rotational speed of the turbine 1 increases from the rotational speed NR1 at which ignition can be made to the rated rotational speed NR2, as shown in FIG. 4A. Therefore, the control signal C13 output from the rotational speed control processing unit 13 increases substantially proportional to the target rotational speed NRsp shown in the graph of FIG. 4A. The curve of the changing target rotational speed NRsp is not limited to that shown in FIG. 4A, but may be set to an appropriate function which includes time t as a variable, for example, to a quadric function or the like.

The target acceleration value ACCELsp is set to be substantially constant so that the rotational speed of the turbine 1 increases from NR1 with a substantially constant acceleration. Therefore, by the control signal C15 output from the acceleration control processing unit 15, the rotational speed may be rendered to increase substantially proportional to a straight line, the proportionality constant of which is the target acceleration ACCELsp.

As mentioned above, the low signal selector 21 selects and passes only the one having the lower value from the control signals C13 and C15 respectively from the rotational speed control processing unit 13 and acceleration control processing unit 15. Therefore, the control signal C21 output from the low signal selector 21 (and hence the control signal C22 output from the high signal selector 22 in a normal operation), serves as a control signal for adjusting the opening degree of the fuel control valve 19 such that the rotational speed changes along a target SP indicated by a solid line in FIG. 4C.

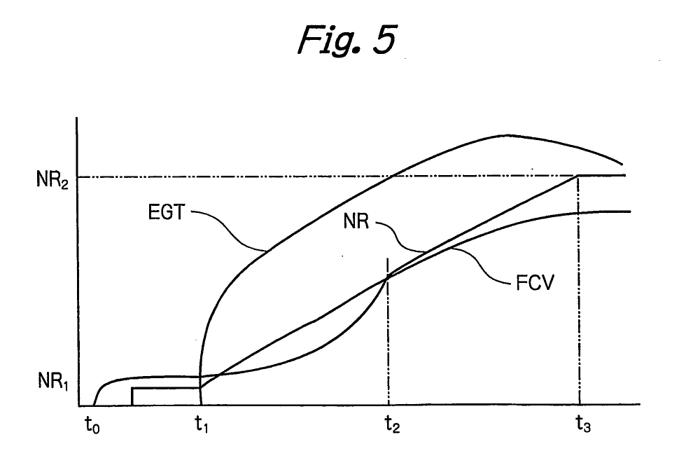

FIG. 5 schematically shows a variety of values (EGT, NR, FCV) upon start-up of the turbine apparatus according to this embodiment, in which the opening degree of the fuel control valve 19 is adjusted in response to the control signal C22. Upon start-up of the gas turbine apparatus 100, a motor 5 (or the generator 5 see FIG. 3A) coupled to the rotation shaft 6 is used as a driving source for starting-up. Specifically, the turbine 1 is driven by the motor 5 to rotate, permitting the turbine 1 to accelerate to the rotational speed NR1 at which ignition can be made. Then, the air/fuel mixture is ignited while the turbine 1 is maintained at this rotational speed NR1 by the motor 5. Following ignition of the air/fuel mixture to generate a combustion gas, the turbine control unit 11 configured as illustrated in FIG. 3B controls the turbine 1 so that its rotational speed follows the target SP as indicated in FIG. 4C.

At time t1 in FIG. 5, i.e., at which control is switched from the motor 5 base control to the turbine control unit 11 base control, the rotational speed of the turbine 1 is changed. In this event, according to this embodiment, the acceleration of the rotational speed of the turbine 1 slowly increases from zero so that the turbine 1 slowly speeds up from time t1 to time t2. Subsequently, the turbine 1 is accelerated at a constant rate from time t2 to time t3, at which the rotational speed NR reaches the rated rotational speed NR2.

As indicated in the graph FCV (opening degree of the fuel control valve 19) in FIG. 5, it is therefore possible to limit the supplied fuel required in this period from time t1 to time t2 to a relatively small amount, by increasing acceleration of the turbine 1 in this period at a rate commensurate with the moment of inertia of the turbine 1. As a result, as indicated in the graph EGT in FIG. 5, the exhaust gas temperature can be prevented from suddenly rising, thereby prolonging the working life of the gas turbine apparatus 100, and particularly the combustor 2.

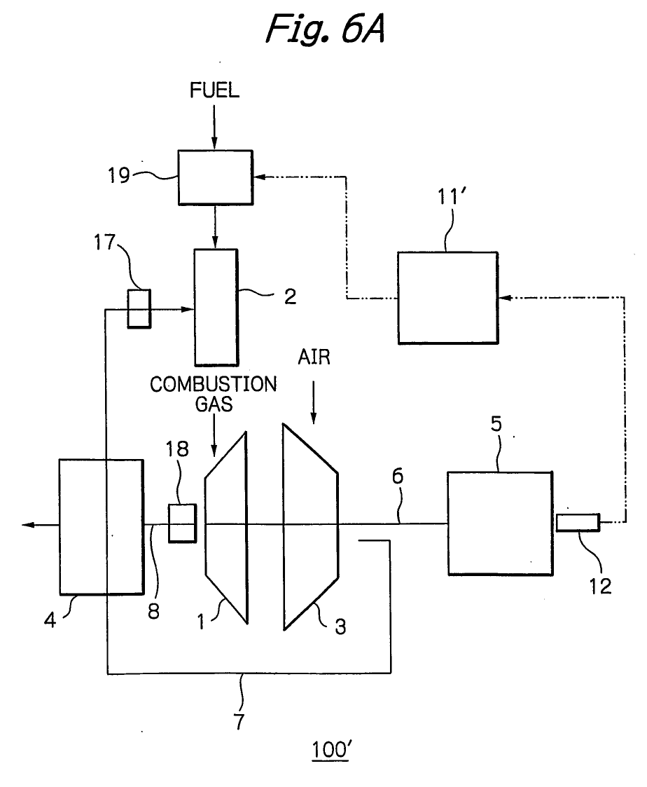

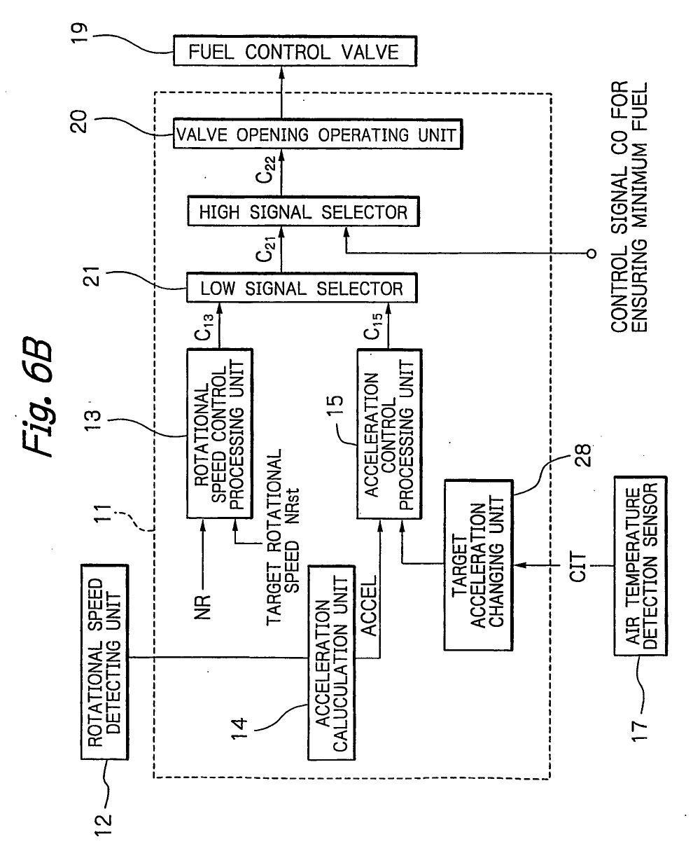

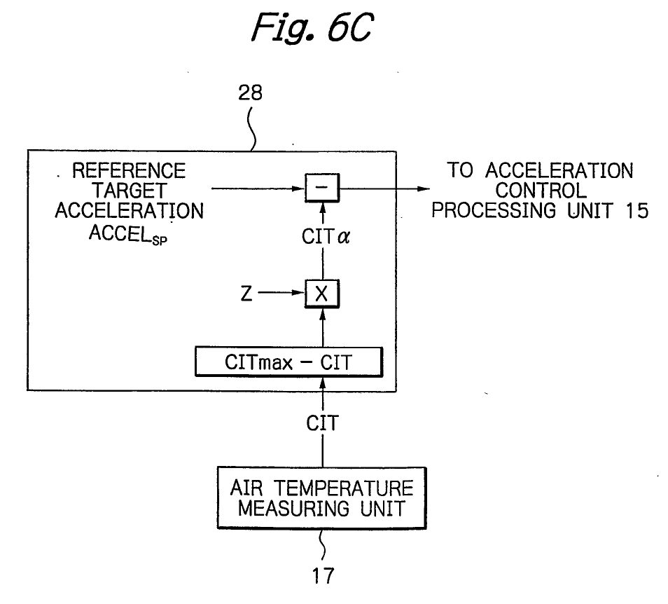

FIGS. 6A and 6B are block diagrams illustrating a gas turbine apparatus 100′ according to a second embodiment of the present invention. In FIG. 6, the same components as those of the gas turbine apparatus 100 in the first embodiment illustrated in FIG. 3 are designated by the same reference numerals, while similar components are designated by the same reference numerals with a symbol “′” added thereto. The following description centers on those components of the gas turbine apparatus 100′ according to the second embodiment, which are not identical to those of the gas turbine apparatus 100 according to the first embodiment, and also on the operations of these components.

Referring to FIG. 6A, the gas turbine apparatus 100′ according to the second embodiment comprises a heat exchanger 4 provided in the gas turbine apparatus 100 of the first embodiment. The heat exchanger 4 uses exhaust gases (mainly, a combustion gas) from the turbine 1 to heat air from the air compressor 3, and supplies the heated air to the combustor 2. The gas turbine apparatus 100′ further comprises an air temperature sensor (CIT sensor) 17 for detecting a temperature of the air supplied to the combustor 2 through the heat exchanger 4, i.e., a combustor inlet air temperature (CIT). The CIT sensor 17 is disposed near an air inlet of the combustor 2.

A temperature of air heated by the heat exchanger 4 can be slowly varied as compared with variations in a temperature of exhaust gases, which depend on a combustion condition in the combustor 2. Also, the heat exchanger 4 forms part of the gas turbine apparatus 100′, and utilizes the heat of the exhaust gases, mainly the combustion gas to heat the air, so that an approximate temperature of the body of the gas turbine apparatus 100′ can be estimated by measuring, with the CIT sensor 17, the temperature of the air heated by the heat exchanger 4.

FIG. 6B is a block diagram illustrating a configuration of a turbine control unit 11′ provided in the gas turbine apparatus 100′ according to the second embodiment. The turbine control unit 11′ differs from the turbine control unit 11 in the first embodiment illustrated in FIG. 3B in that the former comprises a target acceleration changing unit 28 for changing a previously set target acceleration value ACCELsp in accordance with a CIT value from the CIT sensor 17, and a target acceleration value ACCELsp(modified) modified thereby is applied to the acceleration control processing unit 15. Similarly to the turbine control unit 11 in the first embodiment, the high signal selector 22 is not always necessary.

FIG. 6C illustrates a configuration of the target acceleration changing unit 28. The unit 28 is applied with the combustor inlet air temperature CIT from the CIT sensor 17. Upon receipt of the CIT value, the target acceleration changing unit 28 calculates a deviation (CITmax−CIT) of the received CIT value from a maximum combustion inlet air temperature value CITmax allowable to the gas turbine apparatus. Next, the target acceleration changing unit 28 multiplies the resulting deviation by a predetermined constant value Z to calculate a correction value CITα (=Z·(CITmax−CIT)) which is proportional to the deviation. Then, the target acceleration changing unit 28 subtracts CITA from a standard or reference target acceleration ACCEPsp, and supplies the result to the acceleration control processing unit 15 as the modified target acceleration value ACCELsp(modified). It is represented as follows:

ACCELsp(modified)=ACCELsp−CITα

=ACCELsp−Z·(CITmax−CIT) (1)

While the foregoing target acceleration changing unit 28 calculates a deviation of the measured value CIT from the maximum combustor inlet air temperature value CITmax, CITmax may be replaced by an assumed minimum combustor inlet air temperature CITmin. In such a case, the target acceleration changing unit 28 adds CITA to ACCELsp for modification:

ACCELsp(modified)=ACCELsp+CITα

=ACCELsp+Z·(CITmin−CIT) (2)

As is apparent from Equations (1) and (2), the modified target acceleration is smaller than the set reference target acceleration.

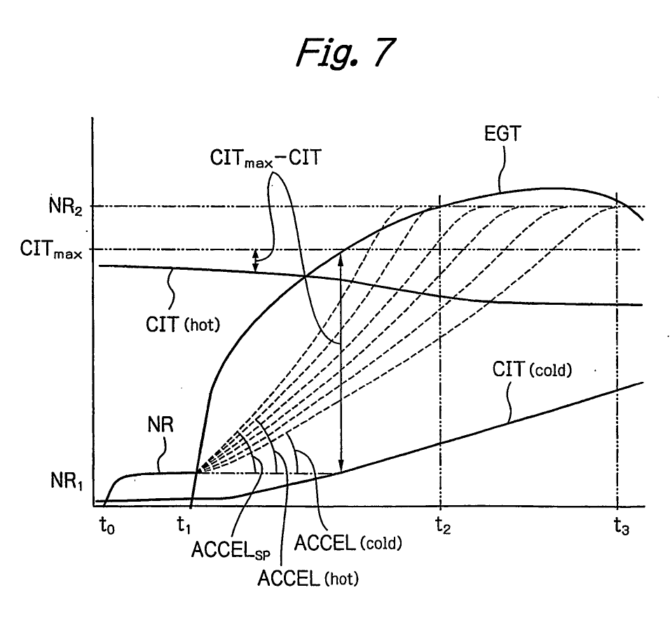

FIG. 7 shows graphs schematically illustrating a variety of values (EGT, NR, FCV) upon start-up of the gas turbine apparatus 100′ according to the second embodiment, which has a function of changing a target acceleration in response to a temperature detected by the CIT sensor. In FIG. 7, the target rotational speed NRsp is set at the rated rotational speed NR2, similarly to a prior art. However, as previously described in connection with the first embodiment, the target rotational speed NRsp may be changed, for example, as shown in FIG. 4A.

In a start-up mode, the turbine 1 is driven by the motor 5 to rotate, and speeded up. Then, as the air/fuel mixture is ignited at time t1 while the turbine 1 maintains the rotational speed NR1 at which ignition can be made, the turbine 1 is accelerated to the rated rotational speed NR2 with the aid of a driving force generated by a combustion gas.

In this event, the reference target acceleration ACCELsp and maximum combustor inlet air temperature CITmax are set as shown in FIG. 7. For example, when the gas turbine apparatus 100′ is re-started immediately after its operation is stopped, the gas turbine apparatus is hot, and therefore the combustor inlet air temperature CIT is high upon starting-up at t0, for example, as indicated by CIT(hot) in FIG. 7. Therefore, the modified target acceleration ACCELsp(modified) calculated in the target acceleration changing unit 28 in accordance with Equation (1) is indicated by ACCEL(hot) in FIG. 7.

On the other hand, when the gas turbine apparatus 100′ is started in a cold state, the combustor inlet air temperature CIT is low upon starting-up at time t0, for example, as indicated by CIT(cold) in FIG. 7. Then, the modified target acceleration ACCELsp(modified) is calculated in accordance with Equation (1), as indicated by ACCEL(cold) in FIG. 7. Since a large difference in temperature is generally found in this event, as compared with a re-start immediately following a stop, CITA has a large absolute value, thus making ACCEL(cold) smaller than ACCEL(hot).

In the example shown in FIG. 7, the target rotational speed NRsp is set to a constant value equal to the rated rotational speed NR2, as mentioned above, so that the low signal selector 21 outputs the control signal C15 but not the control signal C13. In response to the output control signal C15, the opening of the fuel control valve 19 is adjusted to provide the modified target acceleration ACCELsp(modified) (i.e., ACCEL(hot) or ACCEL(cold)), causing the rotational speed NR to increase to the rated rotational speed NR2 as indicated by a dotted line in FIG. 7.

In this way, when the gas turbine apparatus 100′ is cold, the turbine 1 slowly accelerates, so that a less driving force is required as compared with that required for rapidly speeding up the turbine 1, thereby limiting a rise in the exhaust gas temperature EGT. On the other hand, when the gas turbine apparatus is hot, the turbine can be accelerated at a rate approximate to the standard reference target acceleration value ACCELsp, so that the turbine 1 will not be unnecessarily delayed in reaching the rated rotational speed NR2.

In the second embodiment, the target rotational speed NRsp can be also changed in a manner similar to the first embodiment, thereby more appropriately accelerating the turbine.

As described above, according to the first embodiment of the present invention, since the rotational speed is set to gradually increase upon start-up and the like, and the rotational speed control is initially selected and subsequently switched to the acceleration control, the rotational speed of the turbine can be slowly changed. According to the second embodiment, in turn, since the turbine can be accelerated in a variable amount depending on the temperature of the gas turbine apparatus upon start-up, the rotational speed of the turbine can be slowly increased when the temperature is low.

Thus, according to the present invention, it is possible to reduce an amount of supplied fuel required to change a rotational speed, as compared with a prior art. Consequently, the present invention can prevent a sudden rise in exhaust gas temperature, and thereby prolong a working life of the gas turbine apparatus, and particularly the combustor.

Although the invention has been described in its preferred embodiments, it is understood by those skilled in the art that various changes and modifications may be made in the invention without departing from the sprit and scope thereof.

1. A gas turbine apparatus in which a mixture of air and fuel is burnt, and a turbine is supplied with a combustion gas generated by the combustion to drive said turbine to rotate, said gas turbine apparatus comprising:
a turbine control unit for controlling an opening degree of a fuel control valve to control a rotational speed of said turbine, said turbine control unit controlling said opening degree, when changing the rotational speed of said turbine, to monotonically increase the acceleration of the rotational speed of said turbine in a period from a first time at which said change in speed is started to a second time at which said turbine reaches a predetermined fixed target rotational speed.

2. A gas turbine apparatus according to claim 1 wherein said change in speed is an increase in speed in a start-up mode of said gas turbine apparatus, said first time is a time at which an air/fuel mixture is ignited, and said second time is a time at which said turbine reaches a rated rotational speed as the fixed target rotational speed, wherein said turbine control unit comprises:
rotational speed control means to which a process value of a current rotational speed of said turbine and a predetermined variable target rotational speed are provided, for processing them to output a first control signal indicative of an opening degree of said fuel control valve to bring the rotational speed of said turbine to said variable target rotational speed, said variable target rotational speed being set as a predetermined downwardly convex monotone increasing function having a variable factor of an elapsed time over a period from said first time to said second time.

3. A gas turbine apparatus according to claim 2 wherein said turbine control unit further comprises:
acceleration control means to which a process value of a current acceleration of the rotational speed of said turbine and a predetermined constant target acceleration are provided, for processing them to output a second control signal indicative of an opening degree of said fuel control valve to bring the acceleration of the rotational speed of said turbine to the constant target acceleration;
selecting means connected to receive said first and second control signals from said rotational speed control means and said acceleration control means, for selecting one of said control signals which is indicative of a smaller opening degree; and
means for automatically operating said fuel control valve in response to the control signal selected by said selecting means, whereby said turbine control unit controls the opening degree of said fuel control valve initially based on said first control signal and subsequently based on said second control signal in the start-up mode.

4. A gas turbine apparatus in which a mixture of air and fuel is burnt, and a turbine is supplied with a combustion gas generated by the combustion to drive said turbine to rotate, said gas turbine apparatus comprising:
a turbine control unit for controlling an opening degree of a fuel control valve to control a rotational speed of said turbine, said turbine control unit controlling the opening degree, when said gas turbine apparatus is in a start-up mode, such that an acceleration of the rotational speed of said turbine becomes lower as said apparatus is colder.

5. A gas turbine apparatus according to claim 4 further comprising:
a heat exchanger for heating air supplied to a combustor making use of heat of a combustion gas from said turbine; and
an air temperature sensor for detecting the temperature of the air supplied to said combustor, wherein said turbine control unit employs the air temperature from said air temperature sensor as the temperature of said gas turbine apparatus for controlling the acceleration of said turbine.

6. A gas turbine apparatus according to claim 5, wherein said turbine control unit comprises:
target acceleration changing means for modifying a predetermined reference target acceleration value of the rotational speed of said turbine, said target acceleration changing means multiplying an absolute value of a deviation of the air temperature from said air temperature sensor from a predetermined maximum or minimum air temperature by a predetermined coefficient, and subtracting a resulting product from said reference target acceleration to output a modified target acceleration; and
acceleration control means to which a process value of a current acceleration of the rotational speed of said turbine and said modified target acceleration value is provided, for processing them to output a control signal indicative of an opening degree of said fuel control valve to bring the acceleration of the rotational speed of said turbine to the modified target acceleration.

7. A gas turbine apparatus according to claim 6, wherein said turbine control unit further comprises:
rotational speed control means to which process value of a current rotational speed of said turbine and a predetermined constant target rotational speed value are provided, for processing them to output a control signal indicative of an opening degree of said fuel control valve to bring the rotational speed of said turbine to said predetermined target rotational speed;
selecting means connected to receive said control signals respectively from said rotational speed control means and said acceleration control means, for selecting one of said control signals which is indicative of a smaller opening degree; and
means for automatically operating said fuel control valve based on the control signal selected by said selecting means.

8. A gas turbine apparatus according to claim 6, wherein said turbine control unit further comprises:
rotational speed control means to which a process value of a current rotational speed of said turbine and a predetermined target rotational speed are provided, for processing them to output a control signal indicative of an opening degree of said fuel control valve to bring the rotational speed of said turbine to said predetermined target rotational speed, said target rotational speed being set as a downwardly convex monotone increasing function having a variable of an elapsed time in a period from a time at which an air/fuel mixture is ignited to a time prior to a time at which said turbine reaches a rated rotational speed;
selecting means connected to receive said control signals respectively from said rotational speed control means and said acceleration control means, for selecting one of said control signals which is indicative of a smaller opening degree; and
means for automatically operating said fuel control valve based on the control signal selected by said selecting means.
